(19) United States
(12) Patent Application Publication
(10) Pub. No.: US 2007/0295123 A1
(43) Pub. Date: Dec. 27, 2007

(54) Two-stroke gravity power station and method of getting cost-free rotational energy

(76) Inventors: Mikhail Tarnopolsky, Brooklyn, NY (US); Galina Tarnopolsky, Brooklyn, NY (US)

Correspondence Address: Mikhail Tarnopolsky, 7110 Ridge Court, Brooklyn, NY, 11209, US

(21) Appl. No.: 11/431,635

(22) Filed: May 11, 2006

(51) Int. Cl. F16H 27/04; F03G 3/00

(52) U.S. Cl. 74/84 S

(57) ABSTRACT

Two unbalanced rotatable elements provide a phenomenon of getting a specific gravity which decreases in a negative (dead) zone of their free rotation and increases in a positive (active) zone.

### BACKGROUND OF THE INVENTION

The present invention is a new and reliable way of getting cost-free rotational energy as an alternative practical to all other sources of energy. An absolutely simple technical solution makes it easy to build and to use for all kinds of applications, including bicycles and other vehicles. It is important that such energy is very clean. This invention is based on the experimental data of conversion of gravity into rotational energy, which are approved by U.S. Pat. Nos. 5,667,038; 5,921,133; 6,363,807; 6,601,471 on the base of analysis shown on videotapes.

The result of these experiments is a phenomenon of specific gravity, which decreases in a negative (dead) zone of free rotation and increases in a positive (active) zone, where rotation powered by gravity masses. In spite of that, present invention is not exactly a logical completion of what is done and approved by American patents. One revolution cycle of rotation instead of five, any power, speed and size are making a big difference. The present invention also makes a difference to a patent pending 20050137041 (application Ser. No. 10/738,335), because of a much bigger proportion between mechanical energy output and muscular energy input.

### SUMMARY OF THE INVENTION

It is an objective of the present invention to provide a new two-stroke gravity power station and method of getting cost-free rotational energy.

In keeping with these objectives and with others, which will become apparent hereinafter, one feature of the present invention resides, briefly stated in a two-stroke gravity power station and method of getting cost-free rotational energy, which have two rotatable unbalanced elements, which are, at every half of each revolution of their rotation alternately connects to a power shaft and disconnecting from it by means of the third element, which is placed on a spline part of the power shaft between unbalanced elements.

It is automatically moved between them and powered by them by means of the third, fourth, fifth and sixth elements, and due to that provides a generally balanced rotation of the first and second elements and constant torsion moment of the power shaft.

The method of invention includes the steps of moving two equal unbalanced elements, which are connectable to a power shaft every half of each revolution of their movement by means of the third, fourth, fifth and sixth element, and due to that provides a generally balanced rotation of the first and second equal unbalanced elements and constant torsion moment of a power shaft.

The invention itself, however, both as to its construction and to its manner of operation, will be best understood from the following description of a preferred embodiment, which is accompanied by the following drawings.

### BRIEF DESCRIPTION OF THE DRAWINGS

FIG. 1 is a front view of a schematic representation of a two-stroke gravity power station and method of getting cost-free rotational energy.

FIG. 2 is a top view of the gravity power station shown in FIG. 1.

### DESCRIPTION OF A PREFERRED EMBODIMENT

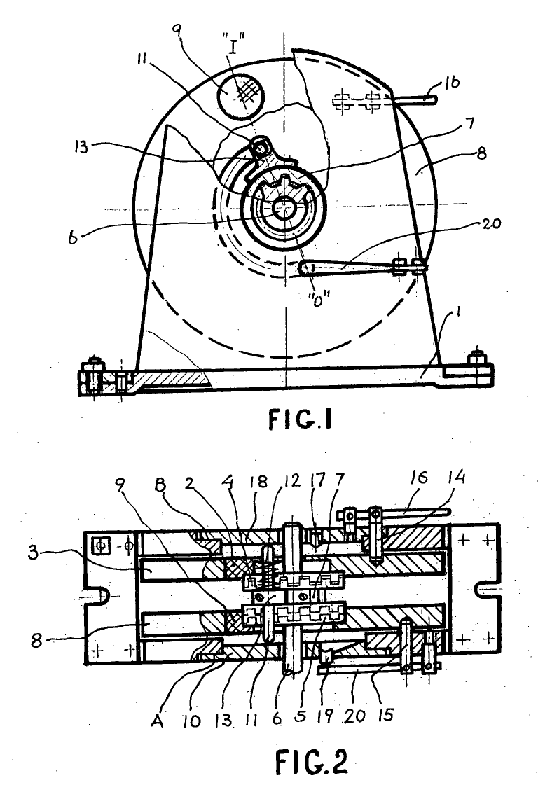

The two-stroke gravity power station for getting cost-free rotational energy includes two equal unbalanced wheels, 3 and 8, with gravity masses 2 and 9, which are placed on their peripheries equal-distantly from the centers of their rotation (FIG. 1, FIG. 2). The wheels 3 and 8 are connectable to a power shaft 6, having a spline part between them for placing on it a spline hub 7 and two parts for placing wheels (3,8) with a kinematical connection between them and power shaft 6 by means of combined overrunning clutches 4 and 5.

Kinematical interaction between the wheels and power shaft might be once at a time. When wheel 3 has it, wheel 8 does not—and the other way around. Kinematical chain for connecting wheels (3,8) with a power shaft 6 or disconnecting them from it begins from the gravity masses 2 or 9 and comes via wheel 3 or 8, and can switch 10, which is attached to “support” 1, via connector 11 with spring 12 on it, which is attached to a striker 13. The last one attached to a spline hub 7 for its moving between wheels (3,8) and alternately connecting them to a power shaft 6 by means of overrunning clutches 4 and 5. FIGS. 1 and 2 are showing the gravity power station in the initial position of gravity masses 2 (wheel 3) and 9 (wheel 8) for their counter-clockwise rotation. Holders 14 and 15 are keeping the wheels (3,8) in this position. Cam switch 10, which attached to the inner surface A of a support 1, is pushing connector 11, spring 12 and striker 13 to the wheel 3, while the spline hub 7 turns the clutch 4 on for kinematical connection between the wheel 3 and power shaft 6.

The first-stroke gravity rotation begins after counter-clockwise turning by hand the lever 16 to release the wheel 3 from the initial position (holder 14 comes out from the wheel 3). After that, the wheel 3 and power shaft 6 start to move together with connecter 11, spring 12, striker 13 and spline hub 7, which are keeping the same functions on the way from the initial position (corner 1) to a lower opposite position (corner 0). This means that clutch 4 is on during ½ of revolution, because connector 11 this whole way touches with the same high cylindrical part of the cam switch 10.

The second-stroke gravity rotation begins by the end of a half revolution movement at the moment when the connector 11 is reaching corner O in the lower position of movement. At this moment, cam switch profile of its connecting with a connector 11 abruptly comes down, and spring 12 comes back pushing connector, striker 13, and spline hub 7 from the wheel 3 to the wheel 8.

During such movements spherical projecture 17 as a moveable part of a cam 18, which is attached to the inner surface B of a support 1, makes an additional strong push of the connector 11 from the back. Due to that, plunger 19 makes a counter-clockwise turn of the lever 20, which pulls out holder 15 from the wheel 8. After that, projecture 17 comes into cam 18 without any function.

Almost at this moment, wheel 3 disconnects from the power shaft 6, and wheel 8 connects with it to provide a phenomenon of a specific gravity, which decreases for a mass 2 in its negative (dead) zone of movement and increases for a mass 9 in a positive (active) zone of its movement. The weightlessness of the mass 2 in the dead zone of rotation was provided by mass 9, which made two unbalanced rotating wheels as a balanced rotating system by means of overrunning clutches 4 and 5. This is the second stroke of conversion of gravity into rotational energy. Alternation of balance and unbalanced condition of rotation, which happens every half of each revolution, leaves out an influence of dead zone and provides one revolution cycle of rotation, which unlimitingly repeats.

The application is not limited to the details shown, since various modifications and changes are possible without changing the patent in any way from the spirit of the invention. For example, in a bicycle gravity masses 2 and 9 are placed underneath the pedals, which are attached to the cranks having the same function as wheels 3,8. Instead of cranks axle, power shaft 6 takes it's place. Two camswitches 10 with opposite profiles are attached to the cranks and one at a time have kinematical interaction with connector 11, which is powered by foot's muscle. Because of this, many details such as spring 12, holders 14,15, levers 16,20 and some others are eliminated. In spite of this, the phenomenon of two-stroke specific gravity exists and works. What is desired to be protected by patent letter is set in the appended claims.

1. Two-stroke gravity power station and method of getting cost-free rotational energy, comprising:
A first rotatable element, having thereon a first unbalanced mass and the second rotatable element, having the same weight as a first element and having thereon a second equal unbalanced mass. During every half of each revolution of their rotation they are powered by gravity masses connecting to output power shaft, and disconnecting from it automatically by means of interactions between unbalanced masses and the third, fourth, fifth and sixth elements. This interaction provides a phenomenon of a specific gravity, having a weightlessness of the unbalanced masses in a negative (dead) zone of their movement and maximum power of weight in a positive (active) zone of their movement. This is due to alternate unbalanced rotation as a first stroke and balance rotation as a second stroke of gravity power station. Alternate unbalanced-balanced rotation excludes dead zone influence and provides unlimited balanced rotation with substantially constant torsion moment of an output power shaft.

2. The system of claim 1, wherein the first and the second rotatable element are similar weight wheels, having thereon equal unbalanced masses, power of which depends on its weights and sizes.

3. The system of claim 1, wherein the third element is a stationary cam, which profile includes the program of alternate strokes.

4. The system of claim 1, wherein the fourth element is three-side connectable spline hub.

5. The system of claim 1, wherein the fifth element is connector.

6. The system of claim 1, wherein the sixth element is a spring.

7. A method of getting two-stroke gravity power station and cost-free rotational energy, comprising the steps of:
Placing a first unbalanced mass on a first rotatable element.
Placing a second unbalanced mass on a second rotatable element.
Connecting the first element and the second element alternate to central shaft by means of the three-side connectable third element.
Alternate connecting the first rotatable element and the second element to a power shaft, which provides alternate of rotation in balanced and unbalanced condition and makes specific gravity. This gravity decreases when the system is balanced and increases when the system is unbalanced.
Alternative “unbalanced-balanced” leaves out dead zone influence and generally provides unlimited balanced rotation with a cycle of one revolution and substantially constant torsion moment of a central shaft.
